(19) United States
(12) Patent Application Publication
(10) Pub. No.: US 2017/0237195 A1
(43) Pub. Date: Aug. 17, 2017

(54) Connector

(71) Applicant: IRISO ELECTRONICS CO., LTD., Kanagawa (JP)

(72) Inventor: Jun Oguro, Kanagawa (JP)

(73) Assignee: IRISO ELECTRONICS CO., LTD., Kanagawa (JP)

(21) Appl. No.: 15/425,352

(22) Filed: Feb. 6, 2017

(30) Foreign Application Priority Data
Feb. 16, 2016 (JP) 2016-026765

(51) Int. Cl. H01R 13/502; H01R 13/6581; H01R 24/60

(52) U.S. Cl. CPC H01R 13/502; H01R 24/60; H01R 13/6581; H01R 2107/00

(57) ABSTRACT

A housing included in a connector, the housing including a first housing formed of a molded body including first terminals, and a second housing formed of a molded body including second terminals. A bottom surface portion of the first housing including fixing holes, and a top surface portion of the second housing including projection portions. The housing being formed by fitting the fixing holes and the projection portions to each other.

### BACKGROUND OF THE INVENTION

1. Field of the Invention

The present disclosure relates to a small-sized connector including a plurality of terminals that comes in conductive contact with an object to be connected.

2. Description of the Related Art

A connector that comes in conductive contact with an object to be connected is known in which terminal rows are disposed on both the front side and the back side of a plate-shaped housing. In such a connector, high-speed data transfer is achieved by having the object to be connected to come in conductive contact with the terminals at both the front side and the back side of the housing (see Japanese Unexamined Patent Application Publication No. 2006-338990, for example).

### SUMMARY OF THE INVENTION

As a method for fixing the terminals to the housing, typically, a method in which the terminals are press-fitted into fixing holes that are for fixing the terminals and that are provided in the housing is employed. However, in such a case, there are cases in which the terminals are deformed or are damaged due to the pressure created when press-fitting the terminals. In particular, in a case in which the connector is small in size, since the terminals are made small and are vulnerable to external pressure, the deformation and the like occurs all the more.

Accordingly, one may conceive of integrally forming the housing and the terminals. Such a method enables the terminals to be easily fixed to the housing without any application of a large pressure. However, in a case in which the terminals and the housing are integrally formed, the terminals need to be fixed so that the terminals are not pushed and moved by resin when the resin is poured into the mold. Accordingly, in a case in which terminals are disposed in two rows overlapping each other, when attempting to fix one of the rows of terminals, the other row of terminals is in the way making it difficult to fix the terminals. Accordingly, there is an issue in that it is difficult to integrally form the housing and the terminals in a case in which, as is the case of the connector described above, the terminals are arranged on both the front side and the back side of the housing.

The present disclosure has been made under such circumstances, and provides a connector in which no deformation and damage occur when fixing the terminals to the housing that includes terminals on both the front side and back side of the housing.

In order to achieve the above object, the present disclosure is configured in the following manner.

In other words, the present disclosure provides a connector including a housing, a plurality of first terminals arranged on a first surface of the housing, and a plurality of second terminals arranged on a second surface of the housing. In the connector, the housing includes a first housing formed of a molded body including the first terminals, and a second housing formed of a molded body including the second terminals. The first housing and the second housing includes a fitting portion in which the second surface of the first housing and the first surface of the second housing are fitted together.

Since the housing includes the first housing and the second housing, and by providing each housing as a molded body including the terminals, fixing to the housing can be performed with the terminals having no deformation and damage. Furthermore, while in a state in which the terminals are fixed to the first housing and the second housing, by fitting the surfaces of first housing and the second housing on the sides on which no terminals, included in the housings, are provided, a connector including terminals on both the first surface and the second surface of the housing can be formed.

The first terminals and the second terminals of the present disclosure may be disposed at the same position in an arrangement direction of the first terminals and that of the second terminals.

With the above, the first terminals and the second terminals can both be in conductive contact with the object to be connected in a similar manner in both cases, that is, in a case in which the first terminals are positioned on the front side and in a case in which the second terminals are positioned on the front side.

The second terminal may include contact pieces that protrude towards a distal end side from the second housing, and the contact pieces may be disposed on the second surface of the first housing.

By disposing the contact pieces on the second surface of the first housing, compared with a case in which both the first housing and the second housing are disposed between the contact pieces and the first terminals, the housing at the above position can be made thin. Furthermore, by so doing, even if there were to be a space created between the first housing and the second housing, an adverse effect such as the gap between the first terminals and the contact pieces becoming large can be prevented from easily happening. Accordingly, a situation such as the object to be connected not easily coming in conductive contact with the terminals can be prevented.

The second surface of the first housing may include terminal grooves that each receive a distal end side of the corresponding contact piece.

With the above, the protruding amount of the contact pieces from the second surface of the first housing can be reduced and the connector can be made thinner. Furthermore, by receiving the distal end sides of the contact pieces in the terminal grooves, a situation such as the object to be connected coming into contact with the distal ends of the contact pieces and buckling the contact pieces can be further prevented from occurring easily.

Each contact piece of the present disclosure may include a biasing portion that is biased towards a second surface side of the first housing so that a distal end side of each contact piece abuts against the second surface of the first housing.

With the above, since the distal end side of the contact piece can be abutted against the second surface side of the first housing and can make separation difficult, a situation such as the object to be connected coming into contact with the distal end sides of the contact pieces and buckling the contact pieces can be further prevented from occurring easily.

The connector may further include a holding member that maintains a state in which the second housing and the first housing are fitted together.

With the above, the first housing and the second housing can be made difficult to become separated.

The holding member of the present disclosure may be a shielding member.

With the above, the holding member can exert both functions, that is, a function of maintaining the fitted state of the first housing and the second housing, and a function of performing electromagnetic shielding. Accordingly, compared with a case in which the above are provided as separate members, the number of parts can be reduced.

The present disclosure can provide a connector including terminals on both the front side and the back side of the housing and a connector in which no deformation, damage, and the like occur when fixing the terminals to the housing. Accordingly, a small-sized connector achieving high-speed transfer can be manufactured with accuracy.

### BRIEF DESCRIPTION OF THE DRAWINGS

FIG. 1 is a perspective view illustrating the front, the right side, and the top of a connector of an exemplary embodiment.

FIG. 2 is an explanatory drawing of the decomposed connector in FIG. 1.

FIG. 3 is a perspective view illustrating the front side, the right side, and the top side of a connector body in FIG. 2.

FIG. 4 is a perspective view illustrating the back side, the right side, and the bottom side of the connector body in FIG. 3.

FIG. 5 is an explanatory drawing of the decomposed connector body in FIG. 3.

FIG. 6 is a perspective view illustrating the front side, the right side, and the top side of a first split body in FIG. 5.

FIG. 7 is a perspective view illustrating the front side, the right side, and the bottom side of the first split body in FIG. 5.

FIG. 8 is an explanatory drawing of the decomposed first split body in FIG. 5.

FIG. 9 is a perspective view illustrating the front side, the right side, and the top side of a second split body in FIG. 5.

FIG. 10 is a perspective view illustrating the front side, the right side, and the bottom side of the second split body in FIG. 5.

FIG. 11 is an explanatory drawing of the decomposed second split body in FIG. 5.

FIG. 12 is a cross-sectional view illustrating a method of fitting the first split body and the second split body in FIG. 5.

FIG. 13 is a cross-sectional view illustrating a connector of in FIG. 1.

FIG. 14 is a cross-sectional view of a modification of the connector.

### DESCRIPTION OF THE PREFERRED EMBODIMENTS

Hereinafter, an exemplary embodiment of a connector of the present disclosure will be described with reference to the drawings. In the exemplary embodiment described hereinafter, a connector 1 that is a USB connector (a universal serial bus) that is mounted on a substrate P and that is in conductive contact with an object to be connected (not shown) will be described as an example.

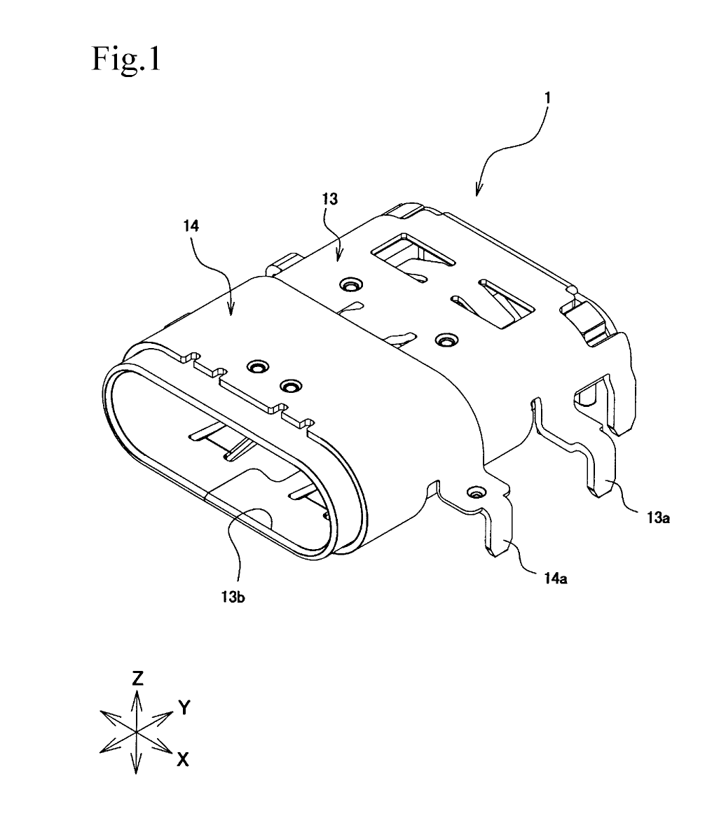

In the present description, claims, and drawings, X direction is a width direction extending in an arrangement direction of first terminals 7 and that of second terminals 11 included in the connector 1 illustrated in FIG. 1, Y direction is a direction in which the object to be connected is inserted into the connector 1, and Z direction is a height direction of the connector 1. Furthermore, the description is given while a flat surface side of the connector 1 in the height direction Z is an “upper side”, and a bottom surface side of the connector 1 is a “lower side”. Moreover, the description is given while, in a front-rear direction Y a side from which the object to be connected is inserted is a “front side” and the side to which the object to be connected is inserted is a “rear side”. However, an up-down direction, a left-right direction, and a front-rear direction in the description do not limit the directions in which the connector of the present disclosure are used and the method in which the connector is mounted.

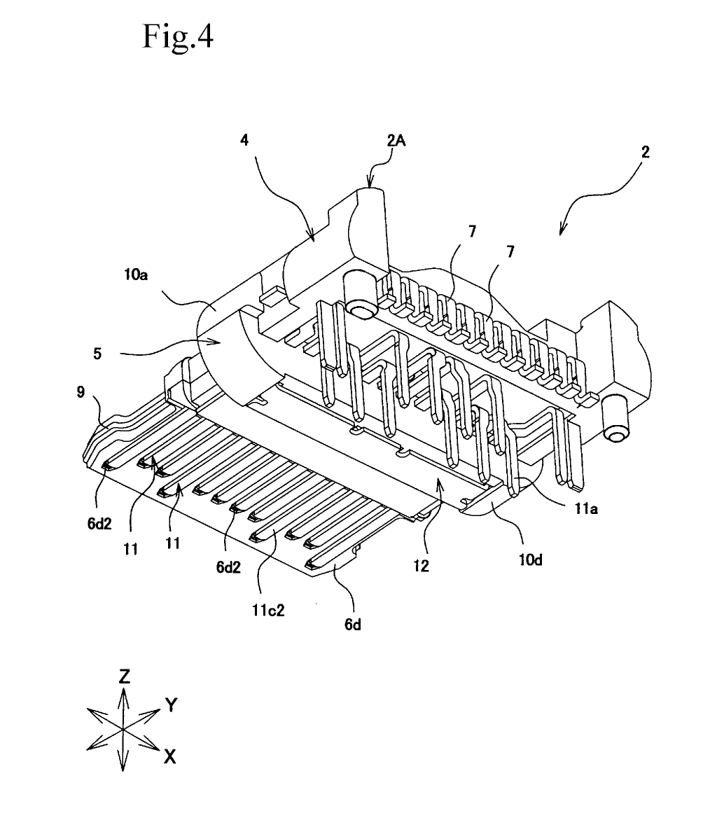

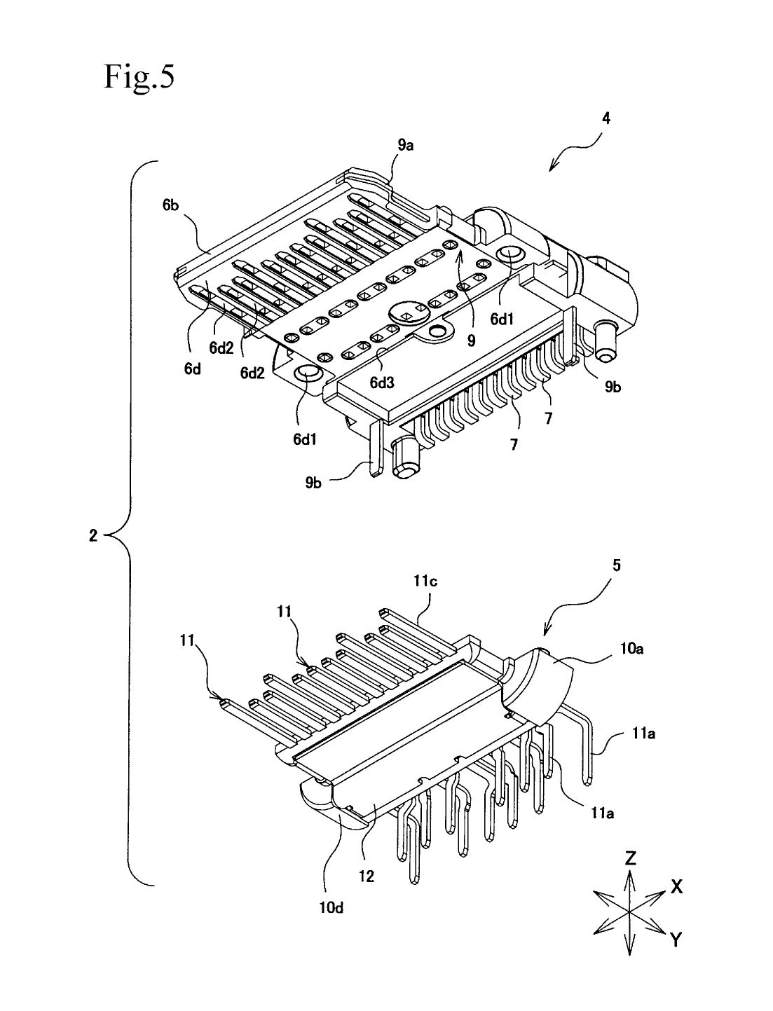

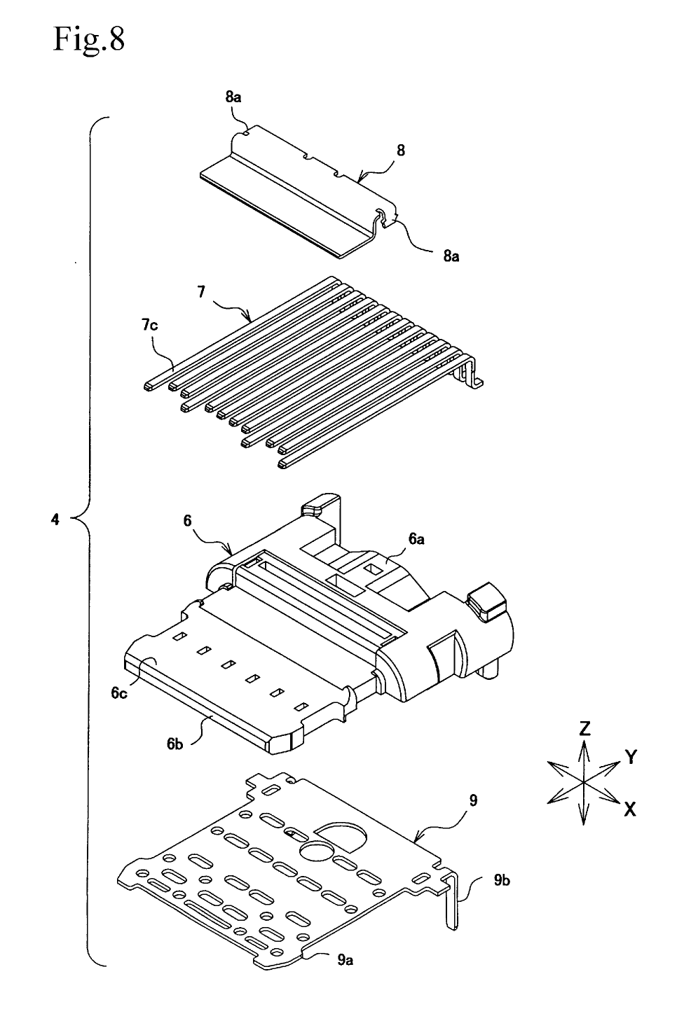

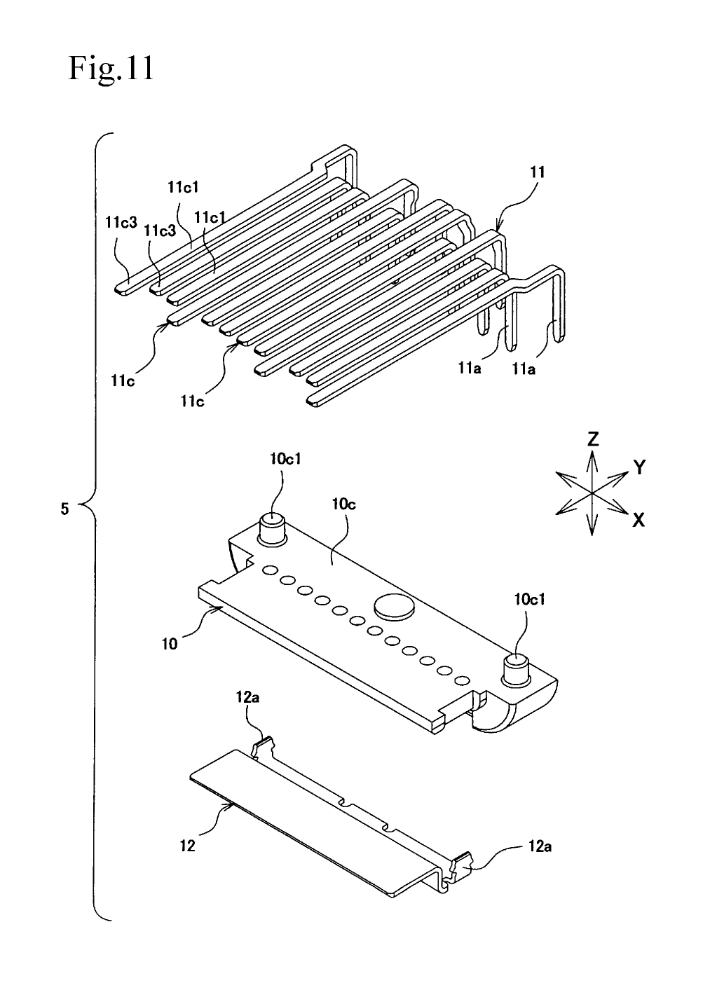

### Exemplary Embodiment [FIGS. 1 to 13]

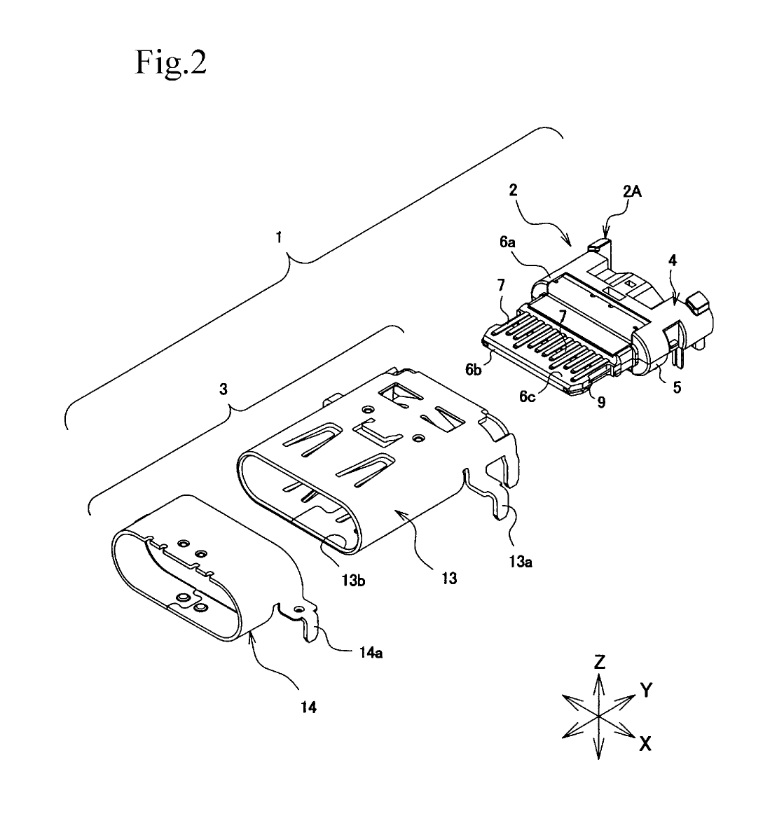

As illustrated in FIGS. 1 and 2, the connector 1 includes a connector body 2 and a cover portion 3.

### Connector Body

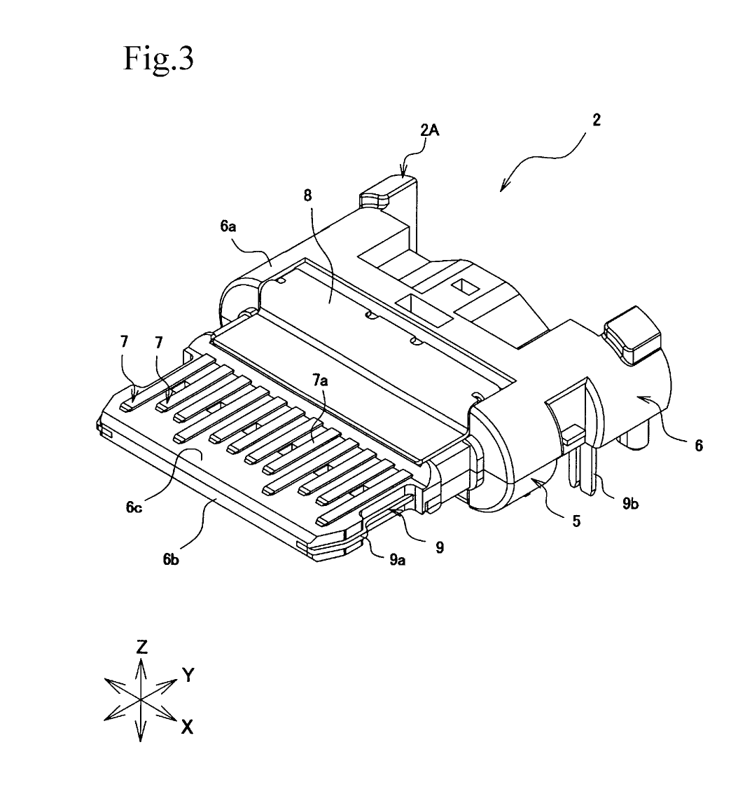

As illustrated in FIGS. 3 to 5, the connector body 2 includes a first split body 4 and a second split body 5. Furthermore, as described later, a housing 2A is formed by fixing a first housing 6 included in the first split body 4, and a second housing 10 included in the second split body 5 to each other.

### First Split Body

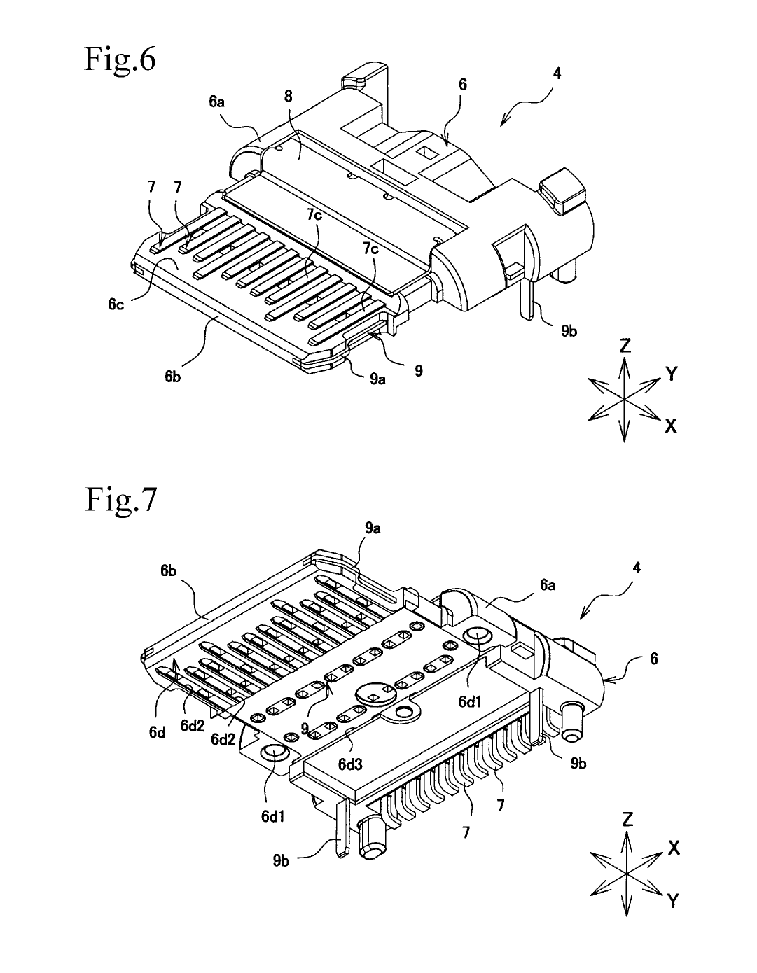

As illustrated in FIGS. 6 to 8, the first split body 4 is constituted by the first housing 6, and the molded bodies of the first terminals 7. The first split body 4 of the present exemplary embodiment further includes a first EMI plate 8 and an intermediate plate 9.

The first housing 6 includes a base portion 6a and a contact holding portion 6b. The first terminals 7 are insert molded to and are held by the base portion 6a. Furthermore, the contact holding portion 6b in the first housing 6 is arranged on the front side with respect to the base portion 6a and is tabular shaped. The first terminals 7 are arranged on a top surface portion 6c, serving as a “first surface” of the first housing, of the contact holding portion 6b. A mounting recess 6d3 that receives the second housing 10 described later is formed in a bottom surface portion 6d, serving as a “second surface”, of the first housing 6. Furthermore, a fixing hole 6d1 is provided on each of the two sides of the mounting recess 6d3 in the width direction X. Furthermore, terminal grooves 6d2 are formed in the bottom surface portion 6d of the first housing 6. Each terminal groove 6d2 receives a single second terminal 11 described later.

The first terminals 7 are surface mount technology (SMT) type pin-shaped terminals. Each first terminal 7 is formed of a conductive metal piece bent in a substantially L-shape and includes, in order from one end thereof, a substrate connecting portion 7a, a housing holding portion 7b, and a contact portion 7c. Each substrate connecting portion 7a is soldered to the substrate P. Each housing holding portion 7b is held inside the base portion 6a of the first housing 6.

The first EMI plate 8 is formed by bending a conductive metal plate and is attached from the base portion 6a to the contact holding portion 6b. Fixing pieces 8a are provided at both ends of the first EMI plate 8 in the width direction X. By press-fitting the fixing pieces 8a into the hole portions (not shown) provided in the upper portion of the first housing 6, the first EMI plate 8 can be fixed to the first housing 6.

The intermediate plate 9 has a tabular shape and is provided as a molded body by being insert molded to the first housing 6. Furthermore, the intermediate plate 9 is disposed at substantially the middle portion of the first housing 6 in the height direction Z. However, since the mounting recess 6d3 is provided on the lower side of the first housing 6, the intermediate plate 9 is exposed from the mounting recess 6d3.

The intermediate plate 9 includes projections 9a that project outputs in the width direction X at the distal end side and at the both end sides in the width direction X, and when the object to be connected and the connector 1 are fitted to each other, the projections 9a are locked to locked portions (not shown) provided in the object to be connected. The connector 1 is retained to the object to be connected in the above manner. Furthermore, the intermediate plate 9 includes leg portions 9b at the rear end thereof. The intermediate plate 9 is grounded by soldering the leg portions 9b to the substrate P.

### Second Split Body

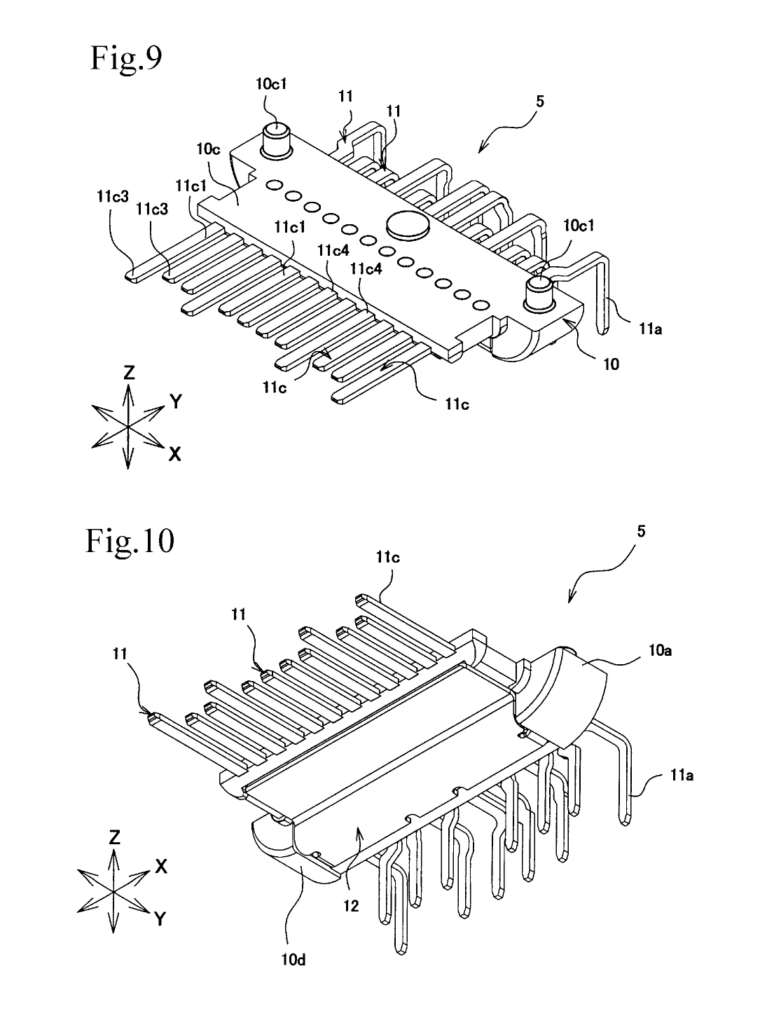

As illustrated in FIGS. 9 to 11, the second split body 5 is constituted by the second housing 10, and the molded bodies of the second terminals 11. Furthermore, the second split body 5 of the present exemplary embodiment further includes a second EMI plate 12.

The second housing 10 includes a base portion 10a. The second terminals 11 are insert molded to and held by the base portion 10a. Projection portions 10c1 each inserted into the corresponding fixing hole 6d1 of the first housing 6 are provided on the two end sides of a top surface portion 10c, serving as a “first surface” of the second housing 10, in the width direction X. The second housing 10 is fixed to the first housing 6 by having the projection portions 10c1 press-fitted in the fixing holes 6d1. The projection portions 10c1 and the fixing holes 6d1 serving as a “fitting portion” hold the first housing 6 and the second housing 10 together such that the connector body 2 is formed. Note that in contrast to the connector 1 of the exemplary embodiment, the second housing 10 may include the fixing holes and the first housing 6 may include the projection portions.

The second terminals 11 are dual in-line package (DIP) type pin-shaped terminals. Each second terminal 11 is formed of a conductive metal piece bent in a substantially L-shape and includes, in order from one end thereof, a substrate connecting portion 11a, a housing holding portion 11b, and a contact piece 11c. Each substrate connecting portion 11a is soldered to the substrate P. Each housing holding portion 11b is held inside the base portion 10a of the second housing 10.

The contact pieces 11c are formed so as to protrude forward from a front end of the base portion 10a. In a state in which the first housing 6 and the second housing 10 are fitted together, the contact pieces 11c are received in the terminal grooves 6d2 formed in the bottom surface portion 6d of the first housing 6. A contact portion 11c2 is formed on an underside of each contact piece 11c. Each contact portion 11c2 protrudes towards the lower side from the bottom surface portion 6d and comes in conductive contact with the object to be connected.

Each contact piece 11c includes a biasing portion 11c1 that is biased towards the bottom surface portion 6d of the first housing 6. In a state in which the first housing 6 and the second housing 10 are fitted to each other, each biasing portion 11c1 is formed as a bending portion that bends towards the bottom surface portion 6d of the first housing 6. Furthermore, the biasing portions 11c1 are provided at the base ends 11c4 of the contact pieces 11c or between the base ends 11c4 and the distal end portions 11c3. By including such biasing portions 11c1, the distal end portion 11c3 of the contact piece 11c can be abutted against the bottom surface portion 6d of the first housing 6 so that that the distal end portion 11c3 does not easily become separated from the bottom surface portion 6d when the first housing 6 and the second housing 10 are fitted together. Accordingly, a situation such as the object to be connected coming into contact with the distal end sides of the contact pieces 11c and buckling the contact pieces 11c when fitting the object to be connected can be prevented from occurring easily.

The second EMI plate 12 is provided by bending a conductive metal plate and is fixed to a bottom surface portion 10d serving as a “second surface” of the second housing 10. Fixing pieces 12a are provided at both ends of the second EMI plate 12 in the width direction X. By press-fitting the fixing pieces 12a into the hole portions (not shown) provided in the lower portion of the second housing 10, the second EMI plate 12 can be fixed to the second housing 10.

### Cover Portion

The cover portion 3 includes a shielding member 13 and a cap portion 14.

The shielding member 13 has a substantially elliptic cylindrical shape formed by bending a conductive metal plate, and has a shape that extends along the external form of the connector body 2. By having the connector body 2 inserted inside the shielding member 13, the connector body 2 is fixed from the outside, such that a state in which the first housing 6 and the second housing 10 are fitted together is maintained. Furthermore, the shielding member 13 includes leg portions 13a that are soldered to the substrate P. An opening portion 13b is formed at the front end of the shielding member 13, and when coming in conductive contact with the object to be connected, the object to be connected is inserted through the opening portion 13b.

Furthermore, the shielding member 13 of the present exemplary embodiment exerts an electromagnetic shielding function by covering the outer periphery of the connector body 2. Accordingly, since the function of maintaining the first housing 6 and the second housing 10 together in a fitted state and the shielding function can be both achieved, compared with a case in which the functions are exerted by different members, the number of parts can be reduced.

The cap portion 14 is formed by bending a conductive metal plate and has a substantially elliptic cylindrical shape that extends along the external form of the shielding member 13. The cap portion 14 is attached from the outside of the distal end side of the shielding member 13. Furthermore, the cap portion 14 includes leg portions 14a that are mounted on the substrate P. The distal end side of the connector 1 can be fixed to the substrate P with the leg portions 14a.

### Method of Assembling Connector

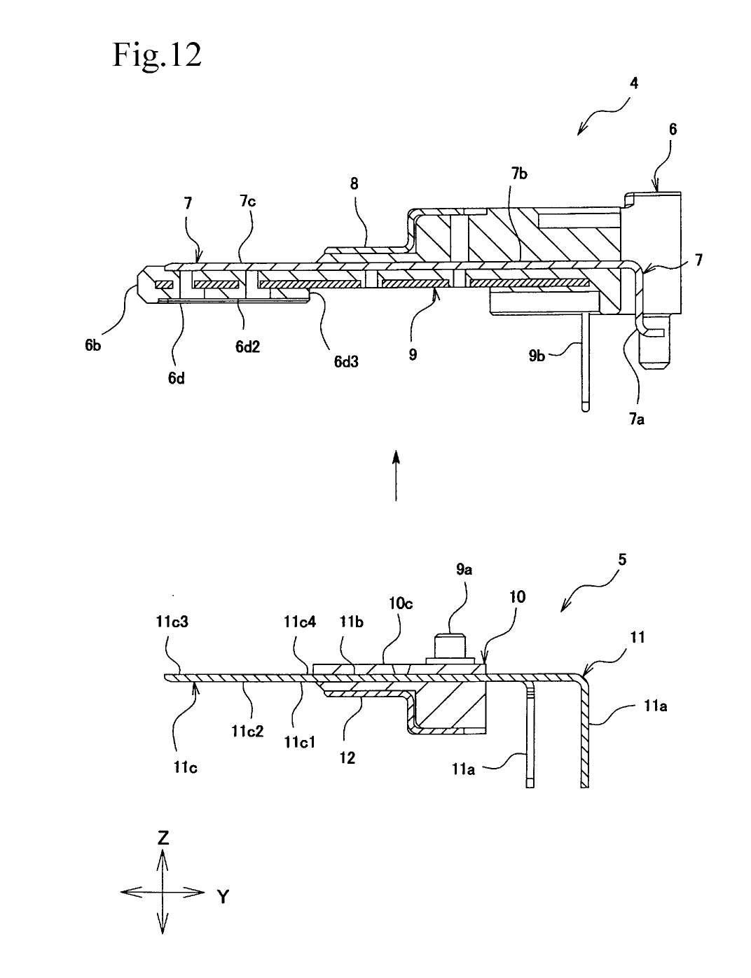

The first split body 4 is assembled first. In other words, the first housing 6, the first terminals 7, and the intermediate plate 9 are formed as a molded body by insert molding. Subsequently, the fixing pieces 8a included in the first EMI plate 8, and the hole portions (not shown) included in the first housing 6 are press-fitted and are fixed together. The first split body 4 is formed in the above manner. Furthermore, the second housing 10 and the second terminals 11 are formed as a molded body by insert molding. Subsequently, the second EMI plate 12 is fitted to the second housing 10 by press-fitting the fixing pieces 12a of the second EMI plate 12 into the hole portions (not shown) included in the second housing 10. The second split body 5 is formed in the above manner. Subsequently, the second split body 5 is fitted into the first split body 4 from the bottom surface portion 6d side of the first housing 6 (see FIG. 12). The connector body 2 is completed in the above manner.

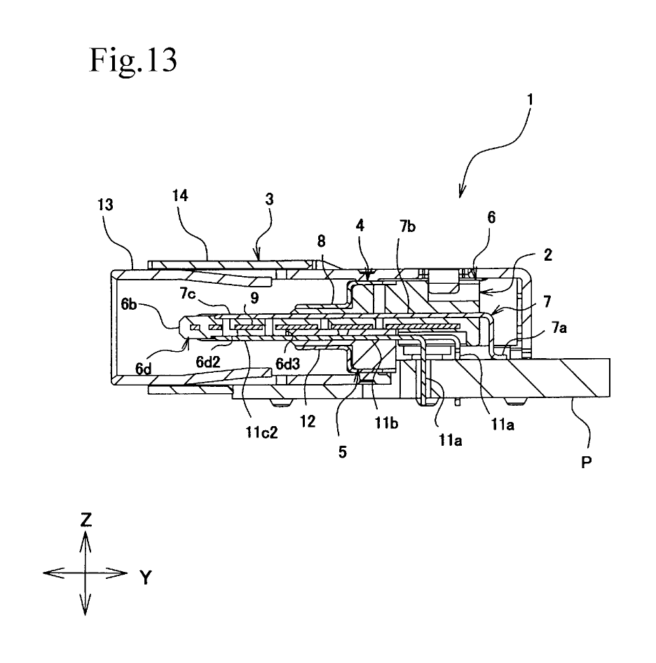

Furthermore, the cover portion 3 is formed by attaching the cap portion 14 to the distal end side of the shielding member 13. By inserting the connector body 2 into the cover portion 3, the assembling work of the connector 1 is completed (see FIG. 13).

The connector body 2 includes the housing 2A formed by fitting the first housing 6 and the second housing 10 to each other. The first terminals 7 are disposed in a parallel manner on a first surface side of the housing 2A, specifically, on the top surface portion 6c of the contact holding portion 6b of the first housing 6, and the second terminals 11 are disposed in a parallel manner on a second surface side, specifically, on the bottom surface portion 6d of the first housing 6. Since the first terminals 7 and the second terminals 11 are disposed at the same position in the width direction X, the first terminals 7 and the second terminals 11 can be made in conductive contact in a similar manner with the object to be connected in both cases, that is, in a case in which the first terminals 7 are positioned on the front side and in a case in which the second terminals 11 are positioned on the front side.

The second housing 10 the present exemplary embodiment is formed shorter than the first housing 6 in the front-rear direction Y, and the front end of the second housing 10 is disposed on the rear side with respect to the front end of the first housing 6. Conversely, if, supposedly, the front end of the second housing 10 is provided flush with the front end of the first housing 6, the front end side of the housing 2A becomes large in the height direction Z since the thicknesses of the first housing 6 and the second housing 10 overlap each other. Furthermore, for example, in a case in which the fixing force becomes weak and a portion of the front end of the first housing 6 and a portion of the front end of the second housing 10 become separated from each other, the object to be connected may be stuck therein and the fitting may become incomplete. Conversely, in the present exemplary embodiment, by having the front end of the first housing 6 and the front end of the second housing 10 be disposed at different positions in the front-rear direction Y, such an occurrence of the above situation can be prevented.

As described above, since the first housing 6 is formed larger than the second housing 10, the second housing 10 of the present exemplary embodiment particularly performs a role as a housing for holding the terminals, which installs and holds the second terminals 11 to the first split body 4. Conversely, contrary to the present exemplary embodiment, the first housing 6 may be formed smaller than the second housing 10 in the front-rear direction Y, and the front end of the first housing 6 may be disposed on the rear side with respect to the front end of the second housing 10. In such a case, the first housing 6 may be configured to perform a role as a housing for holding the terminals, which installs and holds the first terminals 7 to the second split body 5.

Furthermore, a different version of the connector 1, such as a connector 1 that has the same first split body 4 but a different second split body 5, can be formed easily by preparing a second split body 5 that has second terminals 11 having different numbers and shapes. Accordingly, compared with a case in which a connector with terminals having different shapes and the like is formed separately, the versions of the connector can be increased at a lower cost.

As described above, the present exemplary embodiment is capable of, while the first terminals 7 and the second terminals 11 are disposed on the upper and lower sides of the housing 2A, forming a small-sized connector 1 in which the terminals 7 and 11 do not easily become deformed or damaged by buckling and the like. Furthermore, the connector 1 can be manufactured with high accuracy by integrally forming the first terminals 7 and the first housing 6 together, and the second terminals 11 and the second housing 10 together. Since connectors that are out of standard are not easily made, manufacturing can be performed efficiently.

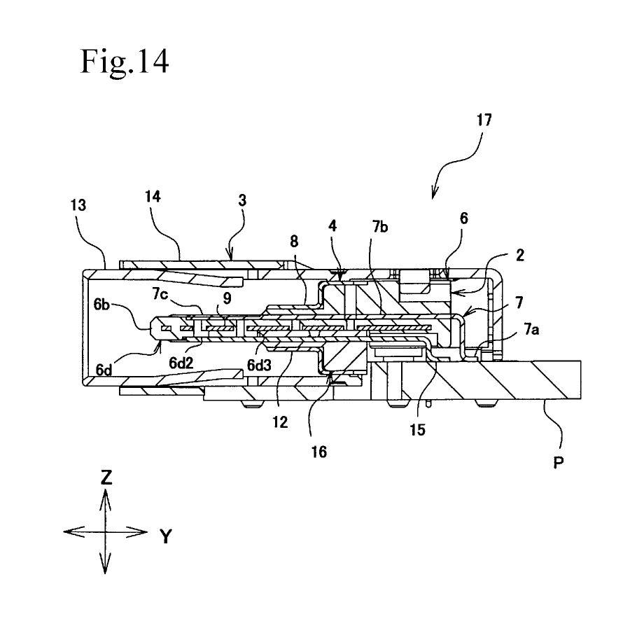

### Modification [FIG. 14]

In the exemplary embodiment described above, the connector 1 in which the second split body 5 includes, as the second terminals 11, the DIP type terminals has been described. However, as illustrated in FIG. 14, the connector may be a connector 17 in which the second split body 5 includes SMT type second terminals 15. With the above, by replacing the second split body 5, the connector can adapt to various mounting methods.

In the exemplary embodiment described above, an example in which the connector body 2 includes the fixing holes 6d1 of the first housing 6 and the projection portions 10c1 of the second housing 10 as the “fitting portion” has been given. However, any other structure that fixes the first housing 6 and the second housing 10 to each other can be adopted. For example, a structure in which the shape of the mounting recess 6d3 is the same or smaller than the shape of the top surface portion 10c of the second housing 10 and in which the second housing 10 is fixed to the mounting recess 6d3 by press-fitting may be formed as the “fitting portion”.

In the exemplary embodiment described above, an example in which the contact piece 11c of each second terminals 11 includes the biasing portion 11c1 formed of a bending portion has been given. However, each biasing portion 11c1 may be formed as a curved portion. Furthermore, as another example, each biasing portion 11c1 may be formed so as to, when fitted in the second housing 10, extend towards the bottom surface portion 6d side of the first housing 6 while curved in an arc from the base end 11c4 side towards the distal end portion 11c3 side of the contact piece 11c. In either of the shapes described above, the biasing portions 11c1 can reliably abut the distal end portion 11c3 of the contact piece 11c against the bottom surface portion 6d of the first housing 6 while in the fitted state.

What is claimed is:

1. A connector comprising:
a housing;
a plurality of first terminals arranged on a first surface of the housing; and
a plurality of second terminals arranged on a second surface of the housing;
wherein the housing includes
a first housing formed of a molded body including the first terminals, and
a second housing formed of a molded body including the second terminals, and
wherein the first housing and the second housing includes a fitting portion in which the second surface of the first housing and the first surface of the second housing are fitted together.

2. The connector according to claim 1,
wherein the first terminals and the second terminals are disposed at a same position in an arrangement direction of the first terminals and that of the second terminals.

3. The connector according to claim 1,
wherein the second terminals include contact pieces that protrude towards a distal end side from the second housing, the contact pieces being disposed on the second surface of the first housing.

4. The connector according to claim 2,
wherein the second terminals include contact pieces that protrude towards a distal end side from the second housing, the contact pieces being disposed on the second surface of the first housing.

5. The connector according to claim 3,
wherein the second surface of the first housing includes terminal grooves that each receive a distal end side of the corresponding contact piece.

6. The connector according to claim 3,
wherein each contact piece includes a biasing portion that is biased towards a second surface side of the first housing so that a distal end side of each contact piece abuts against the second surface of the first housing.

7. The connector according to claim 4,
wherein each contact piece includes a biasing portion that is biased towards a second surface side of the first housing so that a distal end side of each contact piece abuts against the second surface of the first housing.

8. The connector according to claim 5,
wherein each contact piece includes a biasing portion that is biased towards a second surface side of the first housing so that a distal end side of each contact piece abuts against the second surface of the first housing.

9. The connector according to claim 1, further comprising a holding member that maintains a state in which the second housing and the first housing are fitted together.

10. The connector according to claim 9,
wherein the holding member is a shielding member.
